(19) United States
(12) Patent Application Publication
(10) Pub. No.: US 2025/0131423 A1
(43) Pub. Date: Apr. 24, 2025

(54) METHODS AND SYSTEMS FOR PROVIDING OVER-THE-AIR UPDATES OF A VIRTUAL OR PHYSICAL CARD TOKEN

(71) Applicant: Mastercard International Incorporated, Purchase, NY (US)

(72) Inventors: Kaushal Shetty, O'fallon, MO (US); Sachin Kumar Singh, Pune (IN); Venkata Satya Sivajee Pinnamaneni, Dardenne Prairie, MO (US)

(21) Appl. No.: 18/491,700

(22) Filed: Oct. 20, 2023

(51) Int. Cl. G06Q 20/38; G06Q 20/34

(52) U.S. Cl. CPC G06Q 20/385; G06Q 20/34

(57) ABSTRACT

A system and method for enabling dynamic expiration dates in a payment card. An algorithm executes on a computing device to create a private blockchain that is controlled by an inquiry block exchange. A payment card holder (PCH) metablock is generated when a first payment card issuer creates a PCH profile. This PCH profile is maintained within a security zone on the network. The security zone comprises multiple modules. These modules include a dynamic smart contract (DSC) execution engine module for generating a DSC hash value that identifies the DSC for the PCH profile metablock. A hyper-ledger fabric module enables dynamic parameters to be stored as an asset in the DSCs. A metablock generator module creates a PCH profile metablock and hashes the data in a subscribed hashing algorithm. The hashed data includes private keys and cryptographic keys in a secured element section of the PCH profile metablock.

### TECHNICAL FIELD

The present invention relates to methods and systems for updating the security credentials of a payment card token using a private metablock for providing over-the-air security compliance and cryptographic validation updates.

### BACKGROUND

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Recent advances in financial technology have enabled more flexibility in payment card token management. With typical physical payment cards, the token has a fixed account number, expiry date, and security pin. Once the physical payment card reaches its expiry date, it becomes obsolete and cannot be used any longer, regardless of the physical condition of the payment card. This creates several issues. It contributes to excessive plastic waste and environmental degradation with excessive plastic use. It results in declined payment transactions for cardholders as the old card is deactivated after expiration-which is particularly problematic if the old card is stored with merchants for use in recurring transactions. And it also creates a considerable expense for the card issuer. The card issuer has to manage expiry dates on physical payment cards; plan for their eventual expiration; manufacture replacements; update the cardholder's mailing information; process and mail out the new cards; wait for the customer to receive the card; provide mechanisms to activate the card; and then wait for the cardholder to activate the card. This process occurs every 3 to 4 years for every payment card. Therefore, the process of replacing a payment card takes considerable time and resources, while also creating security risks if the new payment card is stolen before it reaches the cardholder.

What is needed is a secure system and method for managing and updating the security credentials of physical payment cards and other payment cards (e.g., virtual and digital) remotely via a secure service provided by the card issuers or payment network. It is an aim of the present disclosure to address these issues.

### SUMMARY

In view of the above needs, a system and method for providing, secure, encrypted over the air updates for the security credentials of physical and digital payment cards and/or tokens are needed. A secure, encrypted private metablock is provided to enable zero expiry payment card tokens. The metablock enables the system to maintain user profiles across the group of different payment card issuers powered by a security zone capable of handling EMV, cardless security compliance updates over the air, and cryptographic validations. Therefore, the card issuers will not have to dispatch a new card post its expiration date. The cards expiration date and security credentials are updated on the private metablock within the security zone.

An embodiment of the present invention provides a system and method for enabling dynamic expiration dates in a payment card token. This is facilitated by a private blockchain that is created and controlled by an inquiry block exchange. When the first payment card issuer creates a first payment card holder profile for the payment card holder; a payment card holder metablock chain is created by a metablock chain generator. The payment card holder profile is created as a metablock and maintained within a security zone on a network. The payment card holder is issued a subsequent payment card from a different payment card issuer, the payment card holder's profile is mapped to the different payment card issuer within the security zone on the network.

In the embodiment, the security zone has multiple modules. A dynamic smart contract (DSC) execution engine module is included. The DSC execution engine generates dynamic smart contract hash values to identify the dynamic smart contracts on the payment card holder profile metablock. A hyper-ledger fabric (HLF) module is provided for enabling dynamic parameters to be stored as an asset within the dynamic smart contracts. A metablock generator (MBG) module is provided for creating the payment card holder profile metablock. The payment card holder profile metablock is used for hashing payment cardholder data in a subscribed hashing algorithm. Here, the hashed payment cardholder data includes private keys and cryptographic keys in a secured element section of the payment card holder profile metablock. An offline services module provides a one-time, offline cryptographic token per block. This offline cryptographic token is updated by a key exchange handshake with a metablock secure element. The hashed payment cardholder data can be accessed by a respective payment card issuer using a private key during a point-of-sale transaction.

In a further embodiment, the inquiry metablock exchange is distributed from a payment processor.

In still another embodiment, the DSC execution engine is identified on the metablock using a hashed DSC address. The DSC address has an owner identification (ID) comprised of a 256-bit hash value. All of the data is hashed before being pushed to the payment card holder's profile metablock. The hyper-ledger enables dynamic parameters to be stored as an asset in the smart contract. An example of a dynamic parameter is the payment card expiration date.

In an embodiment, the metablock generator module creates a user profile metablock that hashes payment cardholder data in a subscribed hashing algorithm while maintaining private keys and cryptographic keys in a secured element section of the payment card holder metablock.

In another embodiment, the one-time offline cryptographic token gets restored as soon as the previous token is consumed.

In an embodiment, if a new payment card issuer issues a new payment card to a payment card holder that already has a prior metablock profile that is associated with a prior payment card issuer, the metablock generator and DSC execution engine assesses the payment card holder's prior metablock profile details. The DSC execution engine then maps the payment card holder's prior metablock profile, that is associated with the prior payment card issuer, to a new metablock profile that is associated with the new payment card issuer.

Of course, it will be appreciated that the present disclosure is not particularly limited to these effects, there may be others.

The foregoing paragraphs have been provided by way of general introduction and are not intended to limit the scope of the invention disclosed herein or the claims set forth herein. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a process flow diagram according to embodiments of the disclosure;

FIG. 2 illustrates a flow diagram according to embodiments of the disclosure;

FIG. 3 illustrates a dynamic smart contract (DSC) execution engine module according to embodiments of the disclosure;

FIG. 4 illustrates a process flow diagram related to an offline services module according to embodiments of the disclosure;

FIG. 5 illustrates a process flow diagram for a hash services module according to embodiments of the disclosure; and

FIG. 6 illustrates a general computing platform according to embodiments of the disclosure.

The figures are described in greater detail in the description and examples below, are provided for purposes of illustration only, and merely depict typical or example embodiments of the disclosure. The figures are not intended to be exhaustive or to limit the disclosure to the precise form disclosed. It should also be understood that the disclosure may be practiced with modification or alteration, and that the disclosure may be limited only by the claims and the equivalents thereof.

### DETAILED DESCRIPTION

Embodiments of the present disclosure are directed to systems, methods, and devices for a method and system for enabling dynamic expiration dates in a payment card token. The details of some example embodiments of the systems, methods, and devices of the present disclosure are set forth in the description below. Other features, objects, and advantages of the disclosure will be apparent to one of skill in the art upon examination of the present description, figures, examples, and claims. It is intended that all such additional systems, methods, features, and advantages be included within this description, be within the scope of the present disclosure, and be protected by one or more of the accompanying claims.

Payment Service Providers—A system or method used for the transfer of money via the use of cash substitutes. Payment Service Providers (PSP) may use a variety of different protocols and procedures in order to process the transfer of money for various types of transactions. Transactions that may be performed via a PSP may include product or service purchases, credit purchases, debit transactions, fund transfers, account withdrawals, etc. PSP may be configured to perform transactions via cash “substitutes,” which may include debit and credit payment cards, letters of credit, checks, transaction accounts, etc. Examples of networks and/or systems configured to perform the function of PSPs include those operated by MasterCard®, VISAR, Discover®, American Express®, PayPal®, Bank to Bank networks, etc. Use of the term “PSP” herein may refer to both the PSP as an entity, corporation, or business; and the physical payment network, such as the equipment, networks, hardware, and software comprising the PSP.

EMV Payment Card-A Europay® Mastercard® Visa® physical payment card (EMV Payment Card) or data token associated with a transaction or banking account that may be provided to a merchant or payee in order to fund a financial transaction via the associated transaction or banking account. EMV Payment Cards may include credit cards, debit cards, charge cards, stored-value cards, prepaid cards, fleet cards, virtual payment numbers, virtual card numbers, controlled payment numbers, etc. An EMV Payment Card may be a physical card that may be provided to a payee, or it may be data representing the associated transaction account (e. g., as stored in a communication device, such as a smart phone or computer). For example, in some instances, data including a payment account number may be considered an EMV payment card for the processing of a transaction funded by the associated transaction account. In addition, the term EMV Payment Card in the discussion herein, is not limited to Europay®, Mastercard® or Visa® payments cards and networks. Instead, pursuant to the discussion herein, an EMV Payment Card can include any physical or digital payment card token, including chip cards, bank-issued cards, Discover®, American Express®, PayPal®, Bank to Bank networks, and other cards and accounts issued by financial service providers, financial technology companies, mobile payment services, and banking institutions.

Blockchain—A public ledger of all transactions of a blockchain-based transaction. One or more computing devices may comprise a blockchain network, which may be configured to process and record transactions as part of a block in the blockchain. Once a block is completed, the block is added to the blockchain, and the transaction record is thereby updated. In many instances, the blockchain may be a ledger of transactions in chronological order, or may be presented in any other order that may be suitable for use by the blockchain network. In some configurations, transactions recorded in the blockchain may include a destination address, hash value, and a smart contract such that the blockchain records the smart contract that is attributable to a specific address. In some instances, additional information may be captured, such as a source address, timestamp, expiration dates, etc. In some embodiments, a blockchain may also consist of additional, and in some instances arbitrary, data that is confirmed and validated by the blockchain network through proof of work and/or any other suitable verification techniques associated therewith. In some cases, such data may be included in the blockchain as part of transactions, such as included in additional data appended to transaction data. In some instances, the inclusion of such data in a blockchain may constitute a transaction. In such instances, a blockchain may not be directly associated with a specific digital, virtual, fiat, or other type of currency.

MetaBlock—A metablock is a logical grouping of blocks in a blockchain derived from various blockchain modules. These blockchains that are generated from various blockchain modules work in conjunction to generate some service or process within the PSP network. In an embodiment of the present invention, a block is generated when a new user opts for this zero-expiry card service via their issuer entity (banks, financial institutions, fintech services, etc.; herein after “issuer bank”). Once the block is generated for this zero-expiry service, each block generated—for each of the user's issuing banks—has designated architecture for holding each of the multiple issuer banks hash keys, smart contracts, security updates, and other data. It is the combination of these individual blocks, which are generated each time the user opts for this service with a different issuing bank, that comprise the metablock zero-expiry card architecture.

Dynamic Smart Contracts (DSC)—A smart contract is a program stored on a blockchain that runs or executes once a predetermined set of conditions are met. A Dynamic Smart Contract is a program that runs on the blockchain once a dynamic set of conditions are met. They are typically used to automate the execution of an agreement so that all participants can be immediately certain of the outcome, without an intermediary's involvement or any loss of time (immediacy).

Inquiry Block Exchange—An inquiry is a request for information. An inquiry block exchange is a system for allowing several metablocks to implement smart contracts that allows several blockchains to exchange information. In an embodiment of the present invention, the inquiry block exchange performs several functions including (1) verifying whether a new block is required for the user or if there is an existing block where this issuer data needs to be pushed; (2) mapping of offline keys with keys stored in the metablock to update the compliance or mandated information in a secured manner; and (3) executing any additional modifications or additions to a blockchain via an issuer bank or DSC engine will be done via the inquiry block exchange.

Payment Card Issuer—A payment card issuer (PCI) is an entity (bank, financial institution, fintech service, etc.; herein after “bank”) that provides credit or debit cards to consumers. The PCI is the bank that has issued a credit or debit card (e.g., EMV card) to a payment card holder (user, customer, account holder; herein after “customer”). Issuing banks are members of a card processing networks, such as Mastercard®, Europay®, or Visa®.

Embodiments herein provide a method and system for enabling dynamic expiration dates in a physical or digital EMV payment card or token (hereinafter “EMV payment card”).

An algorithm executes on a computing device to create a private blockchain on a network that is controlled by an inquiry block exchange. A payment card issuer creates an account containing a customer's profile as the payment card holder (PCH). When the first payment card issuer creates a PCH profile, a block on the block chain is generated containing data, smart contracts, and security features associated with the PCH profile. This PCH profile block is maintained within a security zone on the blockchain network and becomes a component block of the metablock zero-expiry card architecture.

The security zone comprises an inquiry block exchange comprised of multiple modules. These modules include a dynamic smart contract (DSC) execution engine module for generating a DSC hash value that identifies a DSC associated with the PCH profile metablock. A hyper-ledger fabric module enables dynamic parameters to be stored as an asset in the DSCs. A metablock generator module creates a PCH profile metablock and hashes the data in a subscribed hashing algorithm. The hashed data includes private keys and cryptographic keys in a secured element section of the PCH profile metablock. Finally, an offline services module provides a one-time, offline cryptographic token per PCH profile metablock that is updated by a key exchange handshake with a metablock secure element.

Referring now to the drawings, wherein like reference numerals designate identical or corresponding parts throughout the several views.

### System For Zero-Expiry Cards

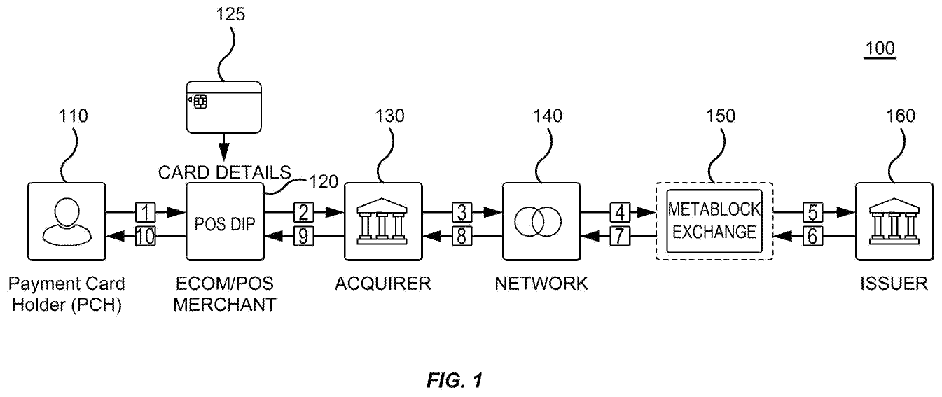

FIG. 1 provides a process flow diagram illustrating the method 100, according to embodiments of the disclosure, for enabling dynamic parameters in a payment card token 125. The payment card token 125 may be a physical EMV payment card or a digital equivalent. In an embodiment, the dynamic parameter includes various EMV chip card data. Whenever a new EMV upgrade happens, it is pushed over the PSP cloud network and can be stored in the EMV chip card 125. In an alternative embodiment, EMV data can include security credentials, such as an expiration date, primary account number (PAN), pin code, security code, biometric, and the like. A payment card holder (PCH) 110 is approved for a payment card and issued an EMV payment card 125 that is associated with a PCH 110 profile containing the PCH's 110 personal and credentialing information at the payment card issuer (PCI) 160. When the PCH 110 engages in a payment transaction at the point of sale (POS) terminal 120 using their EMV payment card 125, the credentialing data associated with the EMV payment card 125 are captured at the POS terminal 120 and that data is transmitted to an acquirer 130 for credentialing and verification purposes. The acquirer 130 then contacts the payment service provider (PSP) network 140 to determine if the account is valid, if funds are available, and if the PCH 110 is authorized to use the EMV payment card 125.

Further in FIG. 1, in an embodiment, the PSP network 140 maintains a metablock exchange (MBE) 150. The MBE 150 allows the system 100 to update and issue dynamic credentials to an EMV chip card 125 via the PSP network 140 in communication with the POS 120 terminal. The PSP network 140 communicates with the PCI 160 which determines if an EMV data update is required for the EMV payment card 125, while also verifying whether funds are available to authorize the transaction purchase at the POS terminal 120. Once the PCH 110 has been validated and approved, the PSP network 140 notifies the acquirer 130 that the transaction has been approved. The PSP network 140 also pushes any new EMV Data updates to the EMV payment card 125 at the POS terminal 120. For example, if the EMV payment card 125 is set to reach its expiry date within a short period of time, the system can update the expiry date of the EMV payment card 125 for another year, for example, which would allow the PCH 110 to continue to use their EMV payment card 125 for another year. In an embodiment, the PCI 160 can push updates to the metablock exchange 150. The customer PCH 110 can at any time, visit any POS 120 or ATM to initiate a non-financial transaction and have the new expiry date (or other data) pushed to the chip on the physical EMV card for future offline transactions.

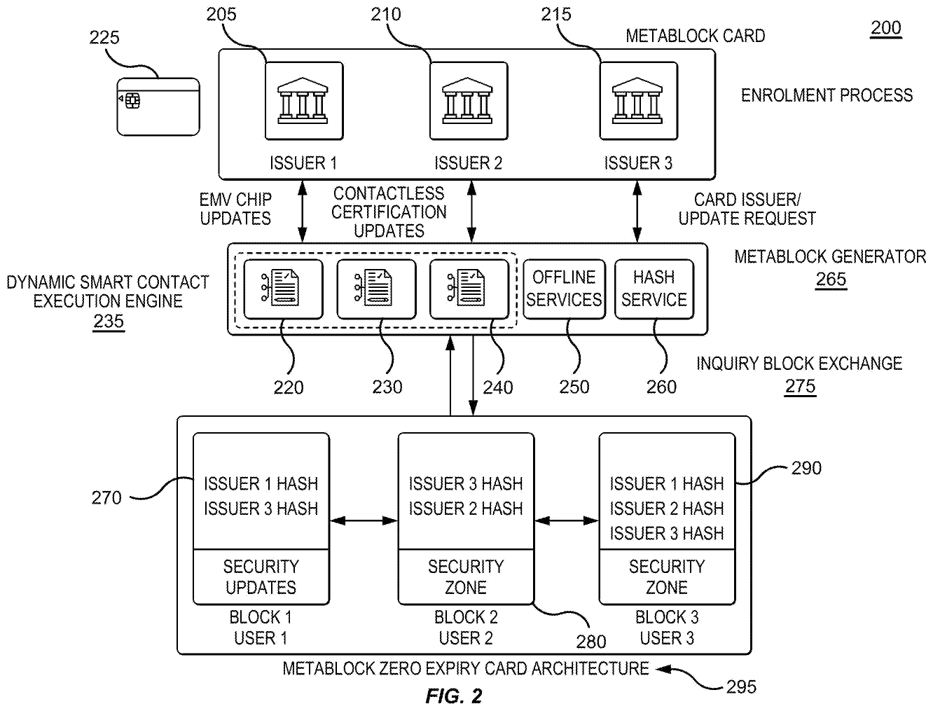

FIG. 2 is a flow diagram illustrating the overall system 200 for enabling dynamic parameters in an EMV payment card 225. Various EMV payment card issuers (PCIs) 205, 210, & 215 can issue an EMV payment card 225 to a customer payment card holder (PCH) 110. When the PCH 110 applies and enrolls in an EMV payment card 225 account, their personal information and security credentials are captured in a PCH profile. The PCIs 205, 210, 215 respectively manage the various PCH 110 accounts associated with each EMV payment card 225 that is issued to the customer PCH 110. Each PCIs 205, 210, 215 is responsible for maintaining the security credentials and integrity of their respective issued EMV payment cards 225.

Further in FIG. 2, a metablock zero-expiry architecture 295 is provided to create private a blockchain controlled by an inquiry block exchange 275, where a payment card holder metablock 220, 230, 240 is created by a metablock generator 265 when a participating PCI 205, 210, 215 for the first time issues a EMV payment card 225 to the PCH 110. In an exemplary embodiment, a PCI 205 issues an EMV payment card 225 to a PCH 110. When the PCI 205 issues the EMV payment card 225 to the PCH 110, a metablock generator 265 creates a payment card holder metablock 220 with the PCH's 110 profile information. This metablock profile 220 is created for each EMV payment card 225 issued by the PCI 205, 210, 215 to the PCH 110. The metablock profile 220 consists of a collection of dynamic smart contracts (DSC) for the PCH 110 credentialing, account, and security information associated with the PCH's 110 EMV payment card 225. The dynamic smart contract execution engine 235 processes these DSCs to create each metablock profile 220, 230, 240 associated with each EMV payment card 225, respectively, that the PCH 110 possess.

The metablock generator 265 then uses the hash services module 260 to assign addresses to the various DSCs associated with each metablock profile 220, 230, 240. The address of the DSCs associated with each metablock profile 220, 230, 240 is a hash value that identifies the DSC on the metablock. The hash service 260 also associates an owner identification (owner ID) with each DSC within each metablock profile 220, 230, 240. The owner ID is a 256-bit hash value that is associated with the owner of the DSC. The owner is mapped jointly with PCI 205, 210, 215 details and the PCH 110 metablock profiles 220, 230, 240, respectively. The owner ID information is hashed before it is pushed to the metablock.

The DSCs are associated with the PCH 110 metablock profiles 220, 230, 240, respectively, within the inquiry block exchange 275. When the PCH 110 uses their EMV payment card 225 at a POS terminal 120 the acquirer 130 begins the process of contacting an inquiry exchange 275 to begin the process of verifying the security credentials and financial balances of the EMV payment card 225 account. The security credentials of the EMV payment card 225 are maintained in its respective PCH 110 profile metablocks 220, 230, 240. In an embodiment, if new security credentials, for example a new expiry date, is needed, the inquiry exchange 275 can push those new credentials out via a new DSC to the PCH's 110 profile metablock 220, 230, 240. In a further embodiment, these new hashed DSCs with updated credentials can be digitally encoded on to the chip within the EMV payment card 225. Therefore, the EMV payment card 225 can continue to be used past its initial expiry date.

In a further embodiment, the system 200 creates a hyper-ledger fabric for metablock creation. The hyper-ledger enables dynamic parameters to be stored as assets within the DSCs. In the embodiment when a PCI 205, 210, 215 issues an EMV payment card 225 to a PCH 110 for the first time, the metablock generator 265 creates a PCH 110 metablock 270 that is associated with that particular EMV payment card 225 and account. The metablock zero-expiry architecture 295 creates a private blockchain (e.g., PCH 110 metablocks 270, 280, 290) that is controlled by the inquiry block exchange 275. Each of the metablocks 270, 280, 290 are created by the metablock generator 265 by associating the PCH 110 profile metablocks 220, 230, 240 with the hash services 260 that provides the addresses of each DSC within the PCH 110 profile metablocks 220, 230, 240 and the offline services module 250 that associates an encrypted key with each of the metablocks 270, 280, 290 respectively. For example, in an embodiment, data in the PCH 110 metablock 270 is encrypted in a hash value along with the encrypted security data. After the first PCH 110 metablock 270 is created for PCI 205; if a different PCI 210 or 215 issues a different EMV payment card 225 to the same PCH 110, then the metablock generator 265 and the DSC execution engine 235 accesses the PCH 110 profile (as described in the DSC execution engine 235) and maps the new EMV payment card 225 and details to the original PCH 110 metablock 270. Therefore, metablock 290 for PCI 205 contains hashed information of PCI 210 and PCI 215 in the example illustrated in FIG. 2. Each metablock 270, 280, 290 then has an associated security zone that can be accessed by respective PCIs 205, 210, 215 using their respective private keys.

The inquiry block exchange 275 is comprised of four modules including: the metablock generator 265; the dynamic smart contract execution engine 235; the offline services module 250; and the hash service module 260. Each of the metablocks 270, 280, 290 are created by the metablock generator 265 by processing the PCH 110 profile metablocks 220, 230, 240 with the hash services 260 that provides the addresses of each DSC within the PCH 110 profile metablocks 220, 230, 240 and using the offline services module 250 to generate an encrypted key (private keys and cryptographic key) in a secured element section of with each of the PCH 110 metablocks 270, 280, 290 respectively. The offline services module 250 generates a one-time offline cryptographic token per metablock 270, 280, 290. The one-time offline cryptographic token is maintained in the security zone of each metablock 270, 280, 290. The one-time cryptographic token gets updated by a key exchange handshake within the metablock secure element. The updated one-time offline cryptographic token is restored as soon as the previous one is consumed.

### Dynamic Smart Contract Execution Engine

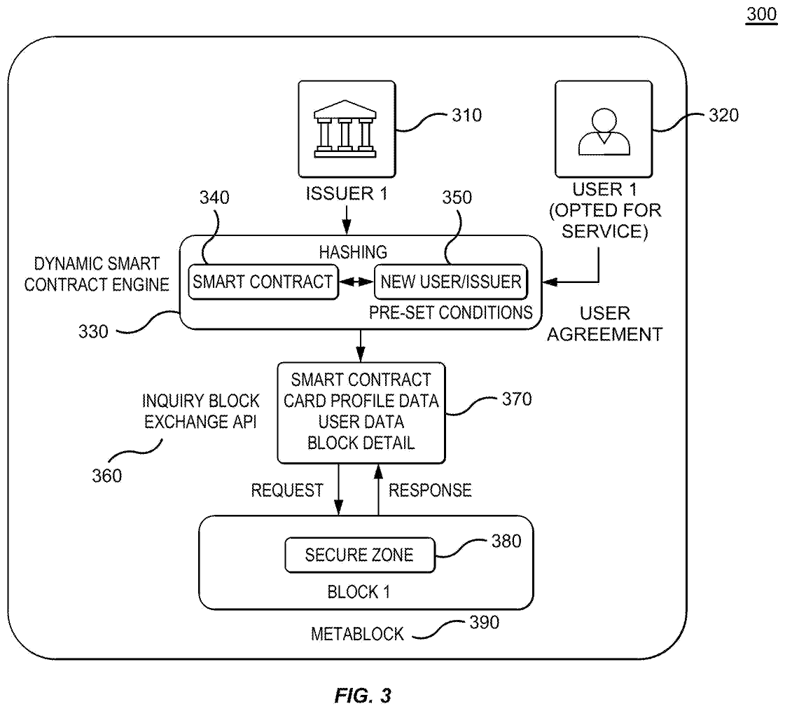

A method of a Dynamic Smart Contract Execution 300 is provided in FIG. 3. A user 320 enrolls into the zero-expiry card service with their bank card issuer 310. Once the user 320 enrolls into the zero-expiry card service, the Dynamic Smart Contract Engine 330 receives the new user/issuer 350 pre-set conditions and profile details to be registered on the block chain with a smart contract 340 user agreement. These user/issuer 350 pre-set conditions and smart contracts 340 are hashed within the block chain. Next an Inquiry Block Exchange API (IBE API) 360 is provided for interacting with financial transaction systems, wherein the smart contract card profile data, user data, and block details 370 and accessible in this exchange. A portion of these details related to the user 320 and their account are accessible via IBE API 360. Certain security details related to the smart contract card profile data, user data, and block details 370 are stored within a secure zone 380. The secure zone 380 contains authentication details such as expiry dates, card verification codes, and other security details. The IBE API 360 handles requests and responses with the secure zone 380 during the users 320 financial transactions and non-financial updates on the user's 320 smart contract data 370. The combination of this secure zone 380 and the smart contract card profile data, user data, and block details 370 creates a metablock 390.

### Offline Services Module

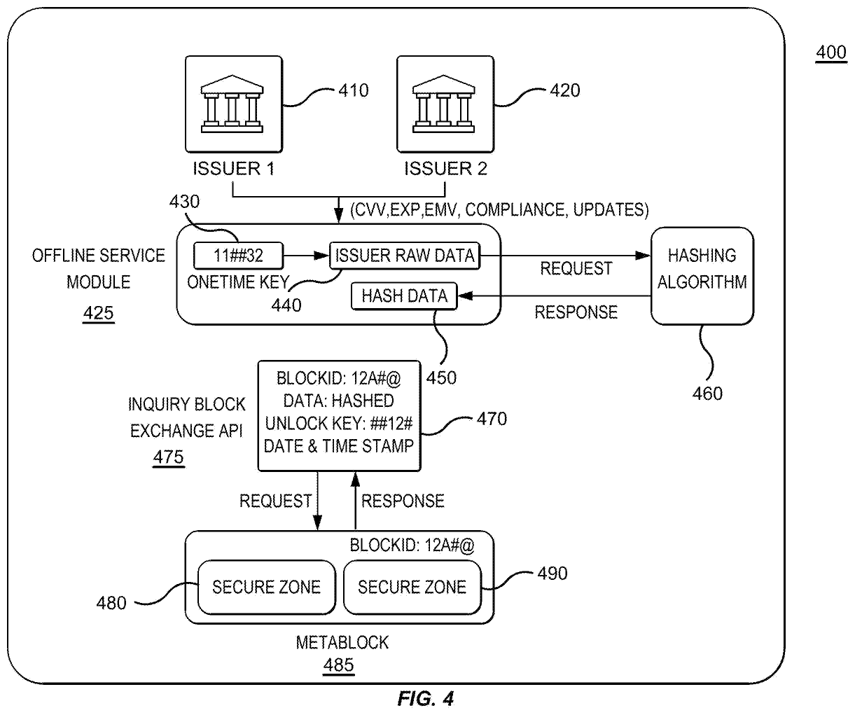

A method for an Offline Services 400 is illustrated in FIG. 4. Offline Services Module (OSM) 425 is provided to allow the physical token cards to be authenticated and updated during a non-financial transaction. In some embodiments, OSM 425 is consistent with or corresponds to offline services module 250 of FIG. 2. A card issuer 410, 420 provides user profiles with EMV card 225 updates for compliance, expiry dates, card verification values (CVV), card verification codes (CVC), and other security details. Each card issuer 410, 420 provides these updates to the OSM 425. Each of the card issuers 410, 420 have secure zones 480, 490 within the metablock 485 respectively. Each card issuer's 410, 420 updates are stored within these respective secure zones 480, 490. The OSM 425 is able to push compliance and other updates from each card issuer 410, 420 to the associated physical EMV card 225. The OSM 425 works with a Hashing Algorithm 460 to map data associated with a Onetime Key 430 and the card issuer 410 raw data 440. The hashed data 450 is provided to the Inquiry Block Exchange API (IBE API) 475. The IBE API 475 contains data related to the Block ID, the hashed data, the unique Onetime Key 430 for unlocking the hashed data, and the date & time stamp 470. The Onetime Key 430 is issued from the metablock 485 secure zone 480, 490 associated with the respective card issuer 410, 420. The IBE API 475 is in communication with these secure zones 480, 490 to provide the hashed security details associated with a given EMV card 225 token to the OSM 425 so that the physical EMV card 225 token can be updated with the new security details during non-financial transaction at a point-of-sale (POS) or automated teller machine (ATM) terminal 120.

The IBE API 475 processes communications between the OSM 425 and the metablock 485. When each card issuer 410, 420 issues an update, the Onetime Key 430 is generated by the card issuer 410, 420 to verify the hashed data. In an embodiment, the Onetime Key 430 is also hashed along with the updates and submitted to the IBE API 475. Once the card issuers 410, 420 provides an EMV card 225 profile update within the metablock 485 that is associated with one of the secure zones 480, 490; a success response is generated within the metablock 485 and forwarded to the respective card issuer 410, 420. In an embodiment, the issuer 410, 420 can then send a short messaging service (SMS) or email notification to the cardholder regarding the updates. The EMV card 225 can be taken to a POS terminal or an ATM 120 to have the update deployed to the chip within the EMV card 225.

### Hash Services Module

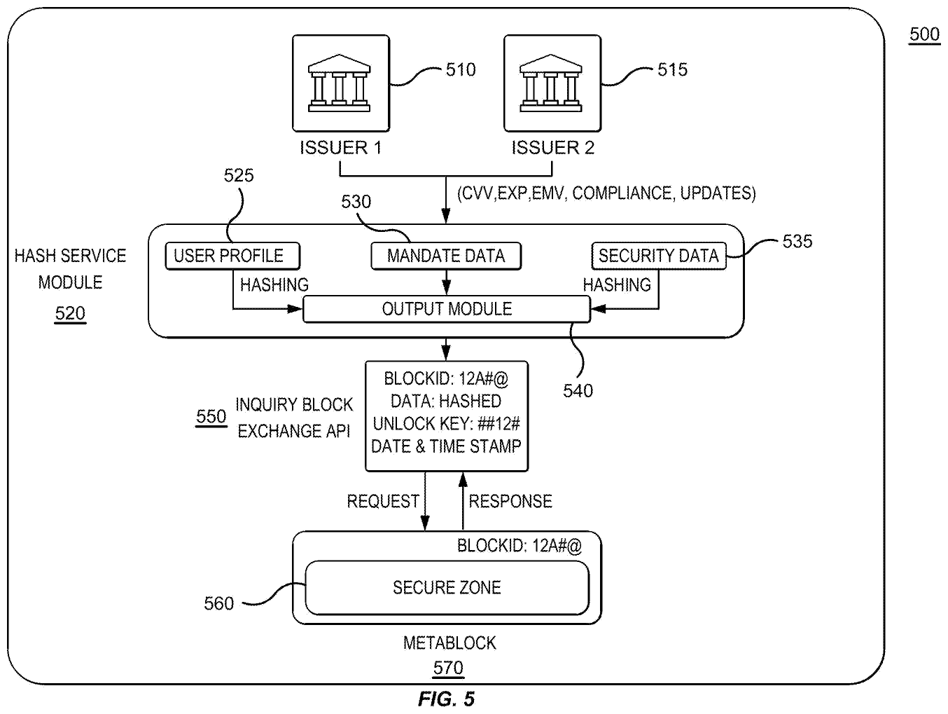

A method of a Hash Services Module 500 is provided in FIG. 5. In some embodiments, the method of the Hash Services Module 500 can be performed, for example, by the hash services module 260 of FIG. 2. The issuers 510, 515 provide user profiles with EMV card 225 updates for compliance, expiry dates, card verification values (CVV), card verification codes (CVC), and other security details. These user profile and data are provided to the Hash Service Module (HSM) 520 where they are addressed and encrypted. Within HSM 520 a user profile 525, Mandate Data 530, and Security Data 535 are encrypted. This data is then addressed/hashed and provided to an output module 540. The Inquiry Block Exchange API 550 (IBE API) receives this encrypted and hashed data long along with the an unlock key. The metablock 570 has an additional secure zone 560 for storing key parameters of the EMV card 225 and the Onetime Key 430 that is used for unlocking the secure zone after which the details and compliance updates associated with a payment card holder's 110 profile are pushed.

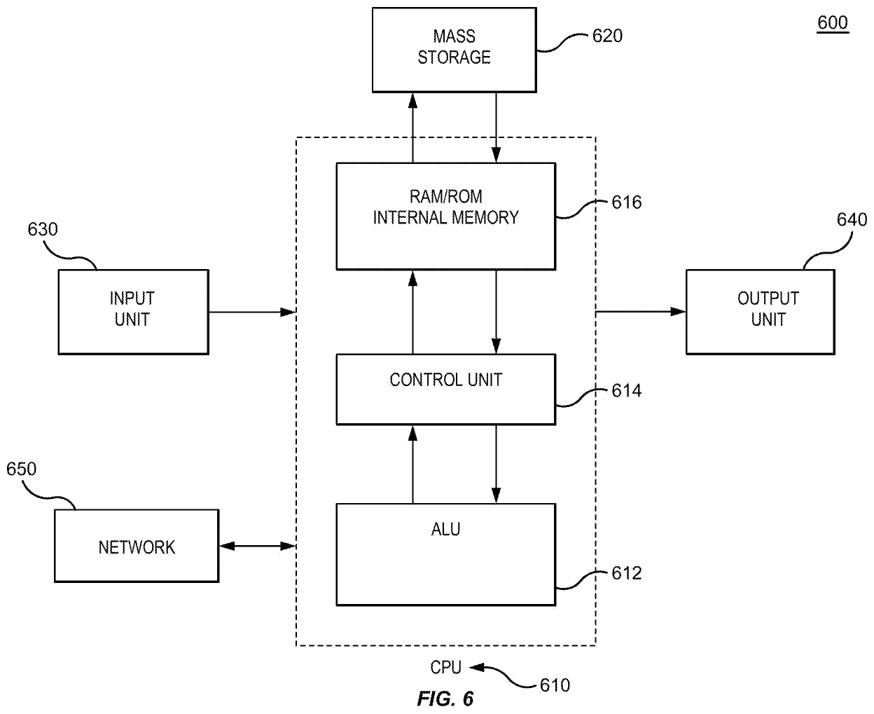

FIG. 6 illustrates a general-purpose computer 600 connected to a network 650. Indeed, in embodiments, the general-purpose computer 600 may also be a server. The general-purpose computer 600 comprises a central processing using 610 in communication with a mass storage device 620. The general-purpose computer 600 receives inputs from an input unit 630. The general-purpose computer 600 produces output via an output unit 640. The general-purpose computer 600 is controlled using a microprocessor or central processing unit 610. The general processing unit 610 is comprised of an arithmetic logic unit 612, a control unit 614, and an internal memory 616. More generally, the general-purpose computer 600 is a data processing apparatus of the disclosure. Typically, the general-purpose computer 600 according to embodiments of the disclosure is a computer device such as a personal computer or a terminal connected to a server. Indeed, in embodiments, the general-purpose computer 600 may also be a server.

Accordingly, in so far as embodiments of the disclosure have been implemented, at least in part, by a software-controlled general-purpose computer 600, it will be appreciated that a non-transitory machine-readable medium or memory 620 carrying such software, such as an optical disk, a magnetic disk, semiconductor memory or the like, is also considered to represent an embodiment of the present disclosure.

It should also be appreciated that one or more aspects of the present disclosure transform a general-purpose computing device into a special-purpose computing device when configured to perform the functions, methods, and/or processes described herein.

Numerous modifications and variations of the present disclosure are possible in light of the above teachings. It is therefore to be understood that within the scope of the appended claims, the disclosure may be practiced otherwise than as specifically described herein.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1) A method for enabling dynamic expiration dates in a payment card token, the method comprising:
creating a private blockchain executing on a computing device and controlled by an inquiry block exchange;
generating a payment card holder (PCH) metablock when a first payment card issuer creates a first PCH profile; wherein the first PCH profile is maintained within a security zone on the network; wherein
the security zone comprising multiple modules including;
a dynamic smart contract (DSC) execution engine module for generating a DSC hash value for identifying the DSC on the PCH profile metablock;
a hyper-ledger fabric module for enabling dynamic parameters to be stored as an asset in the dynamic smart contracts;
a metablock generator module for creating the PCH profile metablock and hashing PCH data in a subscribed hashing algorithm; and wherein the hashed PCH data includes private keys and a cryptographic key in a secured element section of the PCH metablock; and
an offline line services module for providing a one-time offline cryptographic token per block that is updated by a key exchange handshake with a metablock secure element; and wherein
the hashed PCH data can be accessed by a respective payment card issuer using a private key during a point-of-sale transaction.

2) The method according to claim 1, wherein the inquiry metablock exchange is distributed from a payment processor.

3) The method according to claim 1, wherein the DSC execution engine is identified on the metablock using a hashed DSC address.

4) The method according to claim 3, wherein the DSC hash address has an owner identification (ID) comprised of a 256-bit hash value.

5) The method according to claim 4, wherein all data is hashed before being pushed to the PCH profile metablock.

6) The method according to claim 1, wherein the hyper-ledger enables dynamic parameters to be stored as an asset in the DSC.

7) The method according to claim 6, wherein the dynamic parameter can be a payment card expiration date.

8) The method according to claim 1, wherein the metablock generator module creates a user profile metablock that hashes PCH data in a subscribed hashing algorithm while maintaining the private keys and the cryptographic key in a secured element section of the PCH metablock.

9) The method according to claim 1, wherein the one-time offline cryptographic token gets restored as soon as the previous token is consumed.

10) The method according to claim 1, wherein if a new payment card issuer issues a new payment card to the payment card holder associated with the first PCH profile, then
the metablock generator and DSC execution engine assess the first PCH profile details and map the new payment card to the first PCH metablock profile that was generated by the first payment card issuer.

11) A system for enabling dynamic expiration dates in a payment card token, wherein:
in an algorithm executing on a computing device,
creating a private blockchain and that is controlled by an inquiry block exchange;
generating a payment card holder metablock when a first payment card issuer creates a first payment card holder profile; wherein the first payment card holder profile is maintained within a security zone on a network; wherein
the security zone comprising multiple modules;
a dynamic smart contract (DSC) execution engine module for generating a DSC hash value that identifies the DSC for the payment card holder profile metablock;
a hyper-ledger fabric module for enabling dynamic parameters to be stored as an asset in the dynamic smart contracts;
a metablock generator module that creates the payment card holder profile metablock and hashes the payment card holder data in a subscribed hashing algorithm; and wherein the hashed payment card holder data includes private keys and cryptographic keys in a secured element section of the payment card holder profile metablock; and
an offline line services module for providing a one-time offline cryptographic token per payment card holder metablock that is updated by a key exchange handshake with a metablock secure element; and wherein
the hashed payment card holder data can be accessed by a respective payment card issuer using a private key during a point-of-sale transaction.

12) The system according to claim 11, wherein the inquiry metablock exchange is distributed from a payment processor.

13) The system according to claim 11, wherein the DSC execution engine is identified on the metablock using a hashed DSC address.

14) The system according to claim 13, wherein the hashed DSC address has an owner identification (ID) comprised of a 256-bit hash value.

15) The system according to claim 14, wherein all data is hashed before being pushed to the PCH profile metablock.

16) The system according to claim 11, wherein the hyper-ledger enables dynamic parameters to be stored as an asset in the DSC.

17) The system according to claim 16, wherein the dynamic parameter can be a payment card expiration date.

18) The system according to claim 11, wherein the metablock generator module creates a user profile metablock that hashes PCH data in a subscribed hashing algorithm while maintaining private keys and cryptographic keys in a secured element section of the PCH metablock.

19) The system according to claim 11, wherein the one-time offline cryptographic token gets restored as soon as the previous token is consumed.

20) The system according to claim 11, wherein when a new payment card issuer issues a new payment card to a payment card holder associated with the first payment card holder profile;
the metablock generator and DSC execution engine assess the first PCH profile details; and map details associated with the new payment card to the first PCH metablock that was generated by the first payment card issuer.
